(19) United States
(12) Patent Application Publication
(10) Pub. No.: US 2004/0075194 A1
(43) Pub. Date: Apr. 22, 2004

(54) Process for the use of polymeric materials to produce molded foam products

(75) Inventor: Dennis M. Danzik, Scottsdale, AZ (US)

Correspondence Address: THORPE NORTH & WESTERN, LLP., 8180 SOUTH 700 EAST, SUITE 200, P.O. BOX 1219, SANDY, UT, 84070, US

(73) Assignee: Applied Polymer Sciences LLC

(21) Appl. No.: 10/455,740

(22) Filed: Jun. 4, 2003

Related U.S. Application Data
(60) Provisional application No. 60/419,410, filed on Oct. 18, 2002.
(60) Provisional application No. 60/419,411, filed on Oct. 18, 2002.
(60) Provisional application No. 60/419,412, filed on Oct. 18, 2002.
(60) Provisional application No. 60/419,565, filed on Oct. 18, 2002.
(60) Provisional application No. 60/419,730, filed on Oct. 18, 2002.

(51) Int. Cl. B29C 41/04

(52) U.S. Cl. 264/310; 264/328.18; 264/349; 264/523

(57) ABSTRACT

A particulate polymeric blend for use in the formation of molded products formed in the absence of a compounding and/or extruding step prior to molding. A quantity of reactor flake is blended with an effective amount of foaming agent and optional additives to form a particulate foamable polymeric blend at a temperature below the melting temperature of the reactor flake. A wide variety of polymeric reactor flake can be used to produce foamed products. Additionally, a plurality of particulate blends can be blended to provide multiple layer molded products such as foamed-skin products. Molded products produced using these particulate polymeric blends exhibit superior physical properties. Molding processes utilizing such particulate polymeric blends can avoid the use of expensive compounding and pelletizing steps which degrade the quality of the molded polymer.

### PRIORITY CLAIM

This application claims priority to U.S. Provisional Patent Application Nos. 60/419,410; 60/419,411; 60/419,412; 60/419,565; and 60/419,730 each filed Oct. 18, 2002, and each of which are hereby incorporated by reference in their respective entireties.

### BACKGROUND OF THE INVENTION

1. Field of the Invention

The present invention relates generally to polymeric molding processes. As such the invention related generally to the fields of chemistry, materials science, and material processing.

2. Related Art

The past several decades has seen a dramatic increase in the use of polymeric molded articles. For example, growth rates of rotational molding processes have reached up to about 30% per year historically. Rotational molding processes account for a small percentage of the entire plastics molding industry; however the absolute quantities involved are nevertheless substantial, amounting to over 800 million pounds annually. Currently, polyethylene represents about 85% to 95% of all polymers that are rotationally molded. PVC plastisols are widely used while polycarbonates, polyamides, polypropylenes, unsaturated polyesters, ABS, acrylics, cellulosics, epoxies, fluorocarbons, phenolics, polybutylenes, polystyrenes, polyurethanes and silicones constitute the remaining commonly used polymers. A wide variety of rotational molding processes are known for achieving various product designs. Rotationally molded products can be hollow, double walled, single wall foamed, double wall foamed, and a considerable number of other shaped products. Rotational molding processes can incorporate molded parts which include solid inserts, structural members, and the like. Modern Plastics Encyclopedia, pp D-179-180 describes some machinery and materials which can be used in rotational molding and is incorporated herein by reference.

Raw materials available for use in molding has increased dramatically in recent years and includes polymers such as polyethylenes, polypropylenes, polyamides, polyvinyl chlorides, thermosets such as polyesters, and numerous other materials. Commercial options for color selection, multicolor, and foaming processes for polyethylene and polypropylene in particular have improved in recent years. Typical molding processes involve processing of raw polymer from the reactor through an extruder to form pellets. During this extrusion process the polymer is heated while certain additives such as antioxidants and UV absorbers are added. This formed pellet is then further processed using dry blending and/or compounding steps to introduce colorants, blowing agents, and/or further additives. During the compounding process the pellets are again subjected to heat and pressure and then ground to the appropriate mesh size for molding.

### SUMMARY OF THE INVENTION

It has been recognized that it would be advantageous to develop an improved process for preparing and producing materials suitable for use in various molding processes which avoid expensive and time consuming compounding and extrusion processes.

The invention provides a method of producing a particulate polymeric blend for use in the formation of rotationally molded products including the steps consisting essentially of providing polymeric reactor flakes and blending into the reactor flakes an effective amount of a foaming agent and optional additives to form a particulate polymeric blend. The blending process is maintained at temperatures below the melting temperature of the reactor flake.

The polymeric reactor flake can be a wide variety of polymeric materials such as polyethylenes, polypropylenes, polyurethanes, polyvinyl chlorides, polyamides, polyesters, styrenes, ethylvinyl acetates, acrylonitrile-butadiene-styrenes, polycarbonates, acrylonitrile-styrene-acrylates, polyphenylene ethers, fluorocarbons, and mixtures and copolymers thereof.

In one detailed aspect of the present invention, the polymeric reactor flake is polyethylene.

In another aspect of the present invention, the foaming agent can be sodium bicarbonate, soda ash, nitrogen, nitrogen producing agents, and mixtures thereof.

In yet another more detailed aspect of the present invention, additives can be blended with the reactor flakes such as dispersion agents, enhancers, stabilizers, colorants, fillers, crosslinking agents, plasticizers, static inhibitors, pentaerythritol monooleate, glycerol monostearate, mineral oil, lubricants, flame retardants, binders, and mixtures thereof.

In another aspect of the present invention, the polymeric reactor flake can have almost any mesh size and in one aspect has an average mesh size of from about 10 mesh to about 100 mesh.

In still another detailed aspect of the present invention, a filler can be added to the particulate blend such as fiberglass, wood, wood flour, cellulose, waste paper, waste pulp, glass, glass beads, recycled plastics, carbon black, titanium dioxide, and mixtures thereof.

In another aspect of the present invention, the particulate polymeric blend can be molded under pressure and/or heat to form a polymeric product. Molding can be performed by a molding process such as rotational molding, blow molding, injection molding, sheet molding, static molding, and combinations thereof.

In one more aspect of the present invention, a first portion of reactor flakes can be blended under low heat conditions with an effective amount of foaming agent and optional additives to form a particulate foamable polymeric blend. A second portion of reactor flakes can then be blended under low heat conditions with an effective amount of optional additives to form a particulate polymeric blend for use as a skin. The particulate polymeric blend can then be molded under pressure and/or heat to form a skin portion of a polymeric product. The particulate foamable polymeric blend can then be introduced into the mold to produce a foamed-walled final product. In one aspect of the present invention, the particulate foamable blend can be introduced into the mold during cooling of the skin portion.

In yet another detailed aspect of the present invention, the first portion and second portion of reactor flakes are substantially the same material. In another detailed aspect, the first portion and second portion of reactor flakes have differing melt indexes and can be the same or different polymeric material.

Additional features and advantages of the invention will be apparent from the detailed description which follows, taken in conjunction with the accompanying drawings, which together illustrate, by way of example, features of the invention.

### BRIEF DESCRIPTION OF THE DRAWING

FIG. 1 is a flow diagram of one embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

It should be noted that, as used in this specification and the appended claims, the singular forms “a,” “an,” and, “the” include plural referents unless the context clearly dictates otherwise. Thus, for example, reference to “an additive” includes one or more of such additives and reference to “a mixer” includes reference to one or more of such mixers.

In describing and claiming the present invention, the following terminology will be used in accordance with the definitions set forth below.

As used herein, “reactor flake” refers to polymeric reactor product which is unprocessed following the polymerization process. In context of the present invention, reactor flake is essentially free of subsequent compounding, extruding, or any other process which involves substantial heat and/or pressure sufficient to cause melting or a material change to the reactor flake as originally produced. Thus, as used herein, a reactor flake which is pelletized is no longer a reactor flake.

As used herein, “low heat” refers to heat which is insufficient to cause melting of the reactor flake or degradation or change in the chemical and/or physical properties of the reactor flake. In some embodiments, low heat can be used to melt various additives without melting the reactor flake. Thus, low heat includes temperatures from below ambient up to, and not including, the melting temperature of the reactor flake.

As used herein, “melt index” refers to the standardized ASTM measurement of the grams of polymer which can be forced through a die of a specified size at a given temperature and pressure over a 10 minute period. For example, the melt index of polyethylene is measured at 190° C. and application of a 298 kPa force through a 2.1 mm diameter and 8.0 mm length die (polypropylene is measured at 230° C. and the same conditions). The melt indexes and associated measurement conditions of other polymers are well known to those skilled in the art and can be determined by reference to standard technical literature.

As used herein, “complete cooling” refers to the point at which the previously molten polymeric material no longer flows under the molding conditions applied to the material.

As used herein, “substantial” when used in reference to a quantity or amount of a material, or a specific characteristic thereof, refers to an amount that is sufficient to provide an effect that the material or characteristic was intended to provide. Further, “substantially free” when used in reference to a quantity or amount of a material, or a specific characteristic thereof, refers to the absence of the material or characteristic, or to the presence of the material or characteristic in an amount that is insufficient to impart a measurable effect, normally imparted by such material or characteristic.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 10 mesh to about 100 mesh” should be interpreted to include not only the explicitly recited values of about 10 mesh to about 100 mesh, but also include individual values and sub-ranges within the indicated range. Thus, included in this numerical range are individual values such as 20, 30, and 40 and sub-ranges such as from 10-30, from 20-40, and from 30-50, etc. This same principle applies to ranges reciting only one numerical value. Furthermore, such an interpretation should apply regardless of the breadth of the range or the characteristics being described.

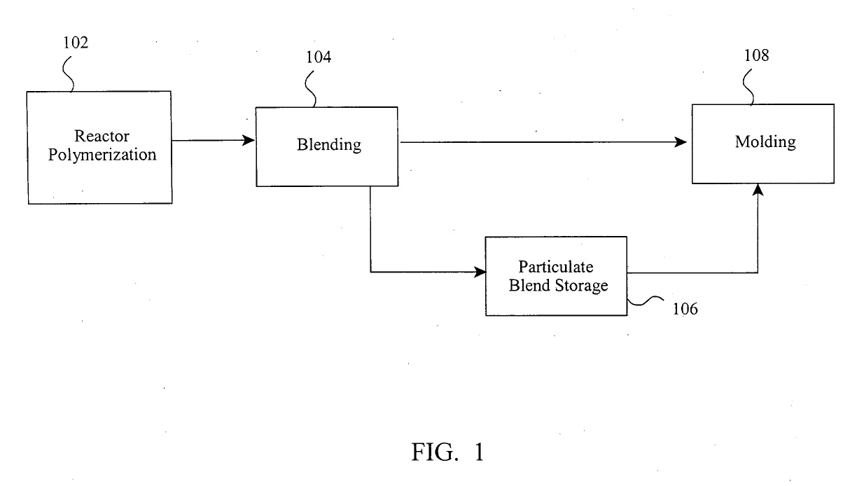

Referring now to FIG. 1, a brief overview of the method of the present invention is provided. A polymeric reactor flake is selected based on the desired properties of a final molded product. The reactor flake is typically a powdered product of a polymerization reaction and a variety of known polymerization processes are known to those skilled in the art. In accordance with the present invention, a quantity of reactor flake is provided at step 102. The reactor flake is then blended under low heat conditions with a foaming agent in step 104 to form a particulate polymeric blend. The particulate polymeric blend can be stored in appropriate means 106 or immediately used in molding step 108. Optional additives can be added to the blend during step 104 or at a later step. Following the blending step 104, the particulate blend is suitable for direct use in various molding processes such as rotational molding. In step 108 the particulate blend is molded into a final product.

In one aspect of the present invention, a particulate polymeric blend for use in forming rotationally molded products utilizes reactor flake which has not been subjected to heat treatments above the melting temperature of the reactor flake prior to molding a final product. Polymeric reactor flakes suitable for use in the present invention can exhibit a variety of properties depending on the reactor conditions. The polymeric reactor flakes can include polymers such as, but not limited to, polyethylenes (including LLDPE, LDPE, HDPE, PET, etc.), polypropylenes, polyurethanes, polyvinyl chlorides (PVC), polyamides, polyesters, styrenes, ethylvinyl acetates, acrylonitrile-butadiene-styrenes (ABS), polycarbonates, acrylonitrile-styrene-acrylates, polyphenylene ethers, fluorocarbons, other elastomeric olefins, butane and hexene based copolymer resins, and mixtures and copolymers thereof. In one specific embodiment of the present invention, the polymeric reactor flake is a polyethylene. In another embodiment, the polymeric reactor flake is HDPE. Polymeric reactor flake of the present invention exhibits high flowability. The lack of a pelletizing and/or grinding step leaves the reactor flake in relatively homogeneous crystalline shapes. Grinding processes leave sharp edges and “tails” which partially interlock among the particles thus decreasing the flowability of the particulate product. The reactor flake and blends resulting therefrom are capable of filling intricate molds. Additionally, the reactor flake of the present invention is not subjected to processing steps prior to molding which involve heating above the melting temperature of the reactor flake. Thus, in one aspect of the present invention temperatures can be maintained below about 85° C. during the blending process and up to the step of molding. Temperatures above this range can be used depending on the specific polymer reactor flake chosen, so long as the reactor flake is not melted or otherwise permanently changed in mechanical or chemical properties.

In another aspect of the present invention, the polymeric reactor flake has an average particle size of from about 10 mesh to about 100 mesh, such as about 35 mesh and can also be less than about 35 mesh. These mesh size ranges are provided merely as illustrative, as mesh sizes outside this range could also be used effectively in the present invention and appropriate adjustments to molding times and processing can be made by those skilled in the art. Additionally, the methods and processes of the present invention can successfully utilize a wide variety of polymer reactor flake having almost any melt index. In one aspect of the present invention the melt index of the reactor flake is from about 0.1 to about 50, and can be from about 4 to about 10 although reactor flake having melt indexes outside this range can also be used. The only limitation as to size and melt index is that of functionality. Current technologies produce reactor flake using slurry or gas phase processes, however any reactor flake product having suitable melt properties can be used in the present invention. Optimal sizes and/or melt indices can be readily determined by one skilled in the art by routine experimentation and may vary depending upon the particular reactor flake being utilized.

Reactor flake can be blended with an effective amount of foaming agent and optional additives to form a foamable particulate polymeric blend. In one aspect of the present invention, the reactor flakes are blended using a standard mixer such as a ribbon mixer, blade mixer, wisk-type mixers, rotary drum mixers, other low or high speed blenders, or similar mixers which do not substantially heat the particulates. Typically, the mixer is also operated at ambient pressures for less than about 30 minutes and more typically from 1 to about 20 minutes. During this blending step a variety of optional additives can be added such as, but not limited to, dispersion agents, enhancers, stabilizers, colorants, fillers, crosslinking agents, plasticizers, static inhibitors, pentaerythritol monooleate, glycerol monostearate, mineral oil, lubricants, flame retardants, binders such as bentonite clay, waxes, and other adhesives, and mixtures thereof. In addition, various additives can be added at a later time just prior to or during the molding process and such addition is considered within the scope of the present invention as not substantially affecting the basic inventive process. Additives can be blended into the reactor flake to achieve a wide range of effects on physical and/or chemical properties such as densities, aesthetic variables, tensile strength, softness, ductility, impact resistance, final surface finish, light stability, and a host of other properties. For example, elastomers and/or plasticizers can be added to increase softness of a polymeric foam. Additionally, the particulate blend of the present invention allows for uniform distribution of colorants, crosslinking agents such as organic peroxides, and other similar additives which improves the quality and appearance of the final molded product. The inclusion of additives to the particulate polymeric blends of the present invention is highly adjustable to conform to the product specifications of individual products in either large or small batches. In some cases, such as with additive colorants, low heat can be added in order to melt and evenly disperse the additive in the blend without melting the reactor flake.

In one embodiment of the present invention, a mixer is used in the absence of other extruders, grinders, and/or pulverizers. In this embodiment, the process of the present invention can be readily transported to a desired location and then removed with minimal effort. Further, the blending steps of the present invention do not require careful climate control of humidity and temperature.

The blending process can be performed using solely dry materials or may include liquid carriers such as oils, water, waxes, paraffins, and blends or mixtures thereof. Suitable carriers can be essentially inert or may impart desirable properties to the foamable polymeric blend such as to increase coating or for processing reasons. However, such carriers preferably do not change the basic physical or chemical properties of the reactor flake. In one aspect of the present invention, the reactor flake can be dried either prior to or after the step of blending using a desiccant, low heat, or other known drying processes. The drying process can improve molding quality and reduce waste and scrap materials.

Due to the absence of compounding or other heat treatments, molded products using the method of the present invention do not require antioxidants or light stabilizing components such as UV stabilizers, although such can still be used. Additionally, the particulate polymeric blends of the present invention are not processed in a compounding step and do not include associated additives used in such processes such as anti-foaming agents, dispersion agents (e.g. zinc stearate), and other catalyst scavengers (e.g. calcium stearate, zinc, and the like) which often reduce the effectiveness of colorants and foaming agents. Further, the addition of known additives either before or after blending with a foaming agent is not considered to materially affect the advantages gained by eliminating steps which involve heating prior to the step of molding. Thus, the process of the present invention can include or omit such additives depending on the desired characteristics in the final molded product.

The particulate polymeric blends of the present invention can be foamed to make substantially closed-cell foams. The polymer blends can also be formed under elevated temperature (thermoformed or thermoset) or elevated pressure (pressure-formed), although elevated temperatures are currently preferred.

Foaming agents suitable in the practice of the present invention can be physical foaming agents or chemical foaming agents. Typically, a physical foaming agent is introduced to the polymer blend in the gaseous or liquid state and expands upon a decrease in pressure. Chemical foaming agents include compositions that are solid or liquid under ordinary processing conditions until the composition is decomposed to release a gas. Chemical foaming agents are typically decomposed at elevated temperatures.

Foaming agents suitable for use in the present invention include but are not limited to, sodium bicarbonate, soda ash, nitrogen, nitrogen producing agents, carbonates, carbon dioxide producing agents, nitroso compounds, azo compounds, hydrazides, and mixtures thereof. For example, chemical foaming agents can include ammonium bicarbonate and ammonium carbonate, azodicarbonamide, sulfonylhydrazides such as benzenesulfonylhydrazine, p-p′-oxybis(benzene)sulfonyl hydrazide, p-toluenesulfonyl hydrazide; p-toluenesulfonyl semicarbazide, azoisobutylonitrile, 5-phenyltetrazole, ethyl-5-phenyltetrazole, dinitroso-pentamethylenetetramine, and other azo, N-nitroso, semicarbazide, sulfonyl hydrazides, and other agent which produce a gas through decomposition and mixtures thereof. Physical foaming agents can include low molecular weight organic compounds including low molecular weight hydrocarbons such as acetylene, propane, propene, butane, butene, butadiene, isobutane, cyclobutane, ethane, methane, ethene, pentane, pentene, cyclopentane, hexane, cyclohexane, and hexadiene; low molecular weight organohalogens, alcohols, ethers, esters, amines; and other compounds such as ammonia, nitrogen, carbon dioxide, neon, or helium. Combinations of various physical and/or chemical foaming agents can be incorporated into the particulate polymeric blends of the present invention. Various additional foaming coagents can also be included in the particulate blend such as salicylic acid, urea and urea derivatives, and other known coagents. The particulate polymeric blend of the present invention can include from about 0.5 to about 20% by weight of foaming agents, and preferably from about 5 to about 10% by weight, although values outside these ranges may be used depending on the specific foaming agent chosen. In one aspect of the present invention sodium bicarbonate is the foaming agent. A wide variety of foaming agents can be used in conjunction with the present invention and are known to those skilled in the art.

The particulate polymeric blend of the present invention can be foamed using a wide variety of polymeric reactor flake. The operating temperatures of the present invention are significantly lower than conventional molding processes and are typically from about 350° F. to about 475° F. and often about 400° F. As such, foamable particulate blends can be made of a variety of polymeric material such as PVC, ABS, polyesters, polyamides, etc. using conventional foaming agents. Pelletized and ground polymeric material typically melts at a higher temperature than the particulate blend of the present invention and results in the foaming agent decomposing prior to melting of the polymer. In addition, additives such as pentaerythritol monooleate and glycerols can lower the processing temperature thus improving the formation of uniformly foamed products.

Many commercially molded products utilize various fillers to both decrease costs and/or improve the mechanical properties of the final molded product. In conjunction with the present invention, fillers are an optional component. A wide variety of fillers can be optionally blended into the particulate polymeric blend of the present invention. Such filler materials can be added either before or after blending the foaming agent therein. Fillers suitable for use in the present invention include, but are not limited to, fiberglass, wood, wood flour, cellulose, waste paper, waste pulp, glass, glass beads, recycled plastics, carbon black, titanium dioxide, and mixtures thereof. Fillers can be present in the particulate polymeric blend in up to about 70% by weight. The fillers can be almost any size or length and are chosen based on the final molded product specifications. Fillers having a large particle size can be successfully used in the present invention which does not involve a compounding or pelletizing step. Thus, large filler particles sizes and/or fiber lengths can be incorporated into a final molded product. For example, fiberglass having an average length of over one inch can be blended into the particulate reactor flake of the present invention and molded as desired.

In accordance with the present invention, the particulate polymeric blend can be molded into a final product under heated conditions using any number of molding processes. Suitable molding processes include rotational molding, blow molding, injection molding, sheet molding, static molding, and combinations thereof. The particulate polymeric blends of the present invention are particularly suited to use in rotational molding. Rotational molding generally involves rotating a heated mold on at least two axes over a period of time. Specifically, a mold having a desired shape corresponding to a specific product is charged with the particulate polymeric blend of the present invention. The amount of particulate blend is calculated to provide the desired thickness and foam density based on the available volume within the mold. The high flowability of the particulate blend allows for uniform distribution of polymer throughout the mold, including molds having relatively intricate shapes. Once the mold is charged with the particulate blend the mold is rotated about at least two axes and heated. The heat can be applied by an oven, a steam jacket, electrical heating elements, or any other heating method. As the mold increases in temperature, the particulate blend melts to partially fill the mold. The foaming agent vaporizes and creates void spaces or bubbles within the molten polymer. Any excess vapor can be released via a pressure release valve. Care should be taken as the heating rate and amount of foaming agent will distinctly affect the size of the foam bubbles, the foam density, and the quality of the final product. Typical operating temperatures are from about 350° F. to about 475° F. Foamable particulate blends can be heated from about 5 minutes to about 20 minutes. Following heating for a given period of time, the heat is removed and the mold is allowed to cool. During at least a substantial portion of the cooling cycle the mold continues to rotate to prevent molten polymer from flowing to create uneven distribution of polymer within the mold. Cooling times can vary, but are typically less than about 20 minutes. These variables will vary somewhat depending on the specific polymer and any additives included in the polymeric blend. For example, a polyethylene reactor flake of about 35 mesh having about 5 wt % sodium bicarbonate foaming agent can be heated to about 400° F. within about 10 minutes and then held for about 10 minutes and then cooled.

Upon completion of the cooling cycle the molded product can be removed from the mold. The molded product can then be finished, if needed, to remove undesirable polymer remnants or otherwise shaped for incorporation into a final product. It should be noted that a variety of inserts can also be incorporated into the molded product such as, but not limited to, metal supports, I-beams, gusset plates, and the like. For example, metal reinforcements or metal parts can be placed in appropriate positions within the mold prior to charging the mold with the particulate polymeric blend of the present invention. Upon completion of the molding process the inserts are integrally incorporated into the molded plastic.

Commercial foam products frequently include a thin polymeric outer shell or skin surrounding the foam. In accordance with one aspect of the present invention, the skin is formed on the interior surface of a rotational mold. A particulate foamable polymeric blend is then injected into the mold allowing formation of a foam within the skin layer. Specifically, a portion of polymeric reactor flake can be blended under low heat conditions with an effective amount of foaming agent and optional additives to form a particulate foamable polymeric blend. A second portion of reactor flakes can be blended under low heat conditions with an effective amount of optional additives to form a particulate polymeric blend for use as a skin. Additional portions of reactor flake can also be blended to achieve multiple layer molded products. Because of the ease with which particulate blends of the present invention can be blended it is sometimes advantageous to prepare various blends from reactor flake just prior to the molding process.

In one detailed aspect of the present invention, the first and second portion of reactor flakes are substantially the same material, i.e. within about 5 melt index units. For example, a quantity of reactor flake can be blended with desired, optional additives, such as those mentioned above. Then a portion of the blended reactor flake can be further blended with a foaming agent. Thus, the same basic starting material can be used to form both the skin and the foam portions of the product. In another detailed aspect of the present invention, the first and second portions of reactor flake are not substantially the same material. The difference between the first and second portion of reactor flake can be average mesh size, melt index, polymeric material, and any combination thereof. For example, the skin portion can be polyethylene while the foam portion can be an ABS polymer.

In an additional aspect of the present invention, more than two portions of reactor flake can be used to form a multiple layer molded product. Each portion can be of substantially similar or different polymeric materials. For example, a soft elastomeric polyethylene skin could be filled with two different foamable particulate blends each having a different firmness, i.e. one highly cushioned and the other rigid. Illustrative examples of molded products having a skin exterior and a foamed interior include without limitation seat cushions, railings, body boards, surf boards, tabletops, automobile bumpers, and other products.

In an alternative embodiment, a portion of the molded product can be formed using standard pelletized polymer and remaining portions can be formed using the blended reactor flake of the present invention. In this way, the cost of producing certain products can be reduced by forming portions of the product using the polymeric blends of the present invention which do not include traditional additives. For example, the outer skin portion of the product can be formed using compounded and ground polymer using known processes. The inner foam portion of a molded product can then be formed using the foamable polymeric blend in accordance with the principles of the present invention.

A wide variety of polymer combinations can be used in the present invention and can be chosen by those skilled in the art based on any particular design criteria. For example, rigid skins can be molded with soft interior foam. Similarly, a soft or cushioned exterior skin can be molded with a rigid foam interior.

The particulate polymeric blend for forming the skin is charged into the mold and then heated as described above in connection with the foamable blend. Prior to complete cooling of the skin material the particulate foamable polymeric blend is introduced into the mold to produce a foamed-walled product. The particulate foamable polymeric blend can be introduced prior to removing the heat source, during initial cooling, during later cooling stages, or combinations thereof. Thus, the entire charge of particulate foamable blend need not be introduced into the mold at the same time. In accordance with the present invention, it is not necessary that nucleation and growth of foam bubbles occur simultaneously. Although, rotational molding is the currently preferred molding process other molding processes can also be used in connection with the method of the present invention such as blow molding, injection molding, sheet molding, static molding, and combinations thereof. Static molding involves charging a mold with the particulate foamable blend and then heating without rotation.

Final molded products of the present invention which use a first and a second portion of reactor flake which are substantially similar have an improved boundary layer. Specifically, as the foamable particulate blend is added the similarity of materials allows for an increase in the mixing of materials at the interface between the skin and foam materials. As a result, there is generally no distinguishable boundary between the two layers in the final product. This results in improved strength in the final molded product. In one embodiment using polyethylene of 35 mesh and having a melt index of about 5 the molded product resulted in no separation between foam and skin layers during a pull-test of over 10 psi of force. Further, molded products produced in accordance with the present invention exhibit increased grain size and decreased crystallinity over typical molding processes which involve pelletizing or other heat treatments of the polymer prior to molding. The molded products of the present invention thus exhibit greater light stability, improved toughness, and strength. In some embodiments, the increased toughness can be moderated by adding various plasticizers or other additives which prevent or reduce fracture under applied force.

### EXAMPLES

The following examples illustrate the embodiments of the invention that are presently best known. However, it is to be understood that the following are only exemplary or illustrative of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following Examples provide further detail in connection with what are presently deemed to be the most practical and preferred embodiments of the invention.

### Example 1

A rotational mold for forming a table was prepared. The mold measured approximately 183 cm in length, 75 cm in width, and about 4 cm in overall thickness. About 4.5 kg of polyethylene reactor flake was mixed with 10 grams of the liquid antioxidant Ergonox 10 (available from Ciba-Geigy Corporation), along with 12 grams of a liquid ultraviolet hindered amine and 8 grams of a liquid colorant. The mixture was blended in a standard propeller style mixer for approximately 15 minutes. The temperature of the mixture was maintained below about 80° C. This mixture was then placed in the mold. The polyethylene reactor flake had an average mesh size of 5 to 60 mesh, a density of 0.938, and a melt index of about 5. The mold was then rotated at about 4 rpm and heated to about 235° C. over a time period of about 20 minutes to completely melt the mixture. The heat source was then turned off and the mold containing a molten mixture was allowed to cool while continuing rotational motion. Within 1 to 5 minutes of removing the heat, a blended polyethylene foam-forming mixture was allowed to flow into the mold from a drop box. This foam-forming mixture contained about 4.5 kg of polyethylene reactor flake, 8 grams of colorant, 0.45 kg of sodium bicarbonate, and did not include antioxidant or ultraviolet inhibitor. After the mold cooled to below about 60° C. the rotational motion was halted and the mold removed to expose the molded skin-foam product.

A cross-sectional sample of the molded product revealed well-formed foam interior. Further, the skin and foam portions were integrally formed such that there was no visible boundary layer. Since the skin material and the resin base for the foam were the same, the transition point from skin to foam was continuous and not laminated. Therefore no delamination can occur. The foam-forming mixture mixed with the interior surface of the skin mixture, becoming a single continuous molding. A density change occurred due to the carbon dioxide released from the sodium bicarbonate blended into the foam-forming mixture. The reactor flake foam-forming mixture has high flow characteristics, even prior to melting, which allowed it to penetrate small areas in the mold, and around inserts.

### Example 2

A rotational mold for forming a commercial swinging door was prepared. The door mold measured 240 cm in length, 120 cm in width and about 3.5 cm thick. A skin-forming particulate blend was produced when 11.5 kg of polyethylene reactor flake was blended with 50 grams of a liquid antioxidant, 40 grams of an ultraviolet inhibitor, and 12 grams of a liquid colorant. The skin-forming particulate blend was blended in a standard propeller style mixer for approximately 15 minutes. The temperature of the particulate blend was maintained below about 80° C. The mold was opened and a 2 cm square steel hinge bar measuring 2.6 meters in length was placed in the mold along with the skin-forming blend. The reactor flake had an average mesh size of 5 to 60 mesh and a melt index of about 6. The mold was then rotated at about 4.5 rpm on the primary axis and about 1.25 rpm on the secondary axis, and heated to about 230° C. over a time period of about 20 minutes to completely melt the skin-forming particulate blend. The heat source was turned off and the mold containing a molten mixture was allowed to cool while continuing rotational motion. Within 5 minutes of removing the heat, a blended polyethylene foam-forming mixture was allowed to flow into the mold from a pneumatically operated drop box. The blended polyethylene foam-forming mixture was produced by mixing 11 kg of 5 melt polyethylene reactor flake, 1 kg of sodium bicarbonate, and 5 ml of mineral oil (used for dispersion and as an antistatic agent) and blended in the same manner as the skin material. The rotation was maintained until the mold cooled below about 65° C. at which time the rotational motion was halted and the mold removed to expose the molded foam product.

A cross-sectional sample of the molded product revealed well-formed foam interior. Further, the skin and foam portions were integrally formed such that there was no visible boundary layer. Since the skin material and the resin base for the foam were the same the transition point from skin to foam was continuous and not laminated. Therefore no do-lamination can occur. The foam melt mixed with the interior surface of the skin becoming a single continuous molded article. A density change occurs due to the carbon dioxide released from the sodium bicarbonate blended into the foam-forming mixture. The foam-forming mixture has high flow characteristics, even prior to melting, which allowed it to penetrate small areas in the mold, and around inserts.

### Example 3

A rotational mold measuring 30 cm long by 15 cm wide by 4 cm thick was used to form various colored rotationally molded foams for laboratory testing. About 300 grams of a non-ground ENGAGE elastomeric polyethylene reactor product (available from Dow Chemical Company) was measured and placed in a food processor type mixer. Approximately 25 grams of sodium bicarbonate was blended with the polyethylene material to produce a mixture. The temperature of the mixture was maintained below about 80° C. About 1 ml of mineral oil was then added to the blend to aid with dispersion and eliminate static electricity. The blended product was mixed for about two minutes. The mixture was then placed in the mold. The elastomeric polyethylene reactor product from Dow was a small round pellet measuring about 3 to 5 mm and had a melt index of about 20. The mold was then rotated at about 15 rpm and heated to about 170° C. over a time period of about 30 minutes to completely melt the mixture. The heat source was removed and the mold containing a molten mixture was then allowed to cool while continuing rotational motion. After the mold cooled below about 60° C. the rotational motion was halted and the mold removed to expose the molded product.

The molded product was a flexible white cushion foam that exhibited good characteristics such as smoothness, even color, and small cell structure. There was little or no static electricity present upon opening the mold, due to the fact that the liquid additive had the affect of eliminating static electricity usually generated in rotational molding.

### Example 4

A rotational mold measuring 30 cm long by 15 cm wide by 4 cm thick was used to form various colored rotationally molded foams for laboratory testing. About 400 grams of polypropylene reactor flake was mixed with 4 grams of a liquid antioxidant along with 4 grams of a liquid ultraviolet light inhibitor and 1 grams of a liquid colorant to produce a particulate skin blend. This particulate skin blend was placed in the mold. The reactor flake had an average mesh size of 5 to 60 mesh and a melt index of about 3. The mold was then rotated at about 4 rpm and heated to about 200° C. over a time period of about 20 minutes to completely melt the particulate skin blend. The heat source was turned off and the mold containing a molten polymeric skin was then allowed to cool. Within 1 to 5 minutes of removing the heat, a blended polypropylene foam-forming mixture was allowed to flow into the mold from a drop box. This foam-forming mixture contained about 150 grams of the polypropylene mixture used above and 15 grams of sodium bicarbonate, without antioxidant or ultraviolet inhibitor. After the mold reached below about 60° C. the rotational motion was halted and the mold removed to expose the molded foam product.

A cross-sectional sample of the molded product revealed well-formed foam interior. Further, the skin and foam portions were integrally formed such that there was no visible boundary layer. Since the skin material and the resin base for the foam were the same the transition point from skin to foam was continuous and not laminated. Therefore no do-lamination can occur. The foam melt mixed with the interior surface of the skin melt, becoming a single continuous molding. A density change occurs due to the carbon dioxide released from the sodium bicarbonate blended into the foam-forming mixture. The reactor flake foam mixture has high flow characteristics which allowed it to penetrate small areas in the mold, and around inserts.

### Example 5

Ethylene vinyl acetate reactor flake having 9 wt % or greater of vinyl acetate was blended with mineral oil and placed in a rotational mold. The mold was then rotated at about 15 rpm and heated to about 170° C. over a time period of about 30 minutes to completely melt the mixture. The heat source was removed and the mold containing a molten mixture was then allowed to cool while continuing rotational motion. After the mold cooled below about 60° C. the rotational motion was halted and the mold removed to expose the molded product.

The molded product was a flexible foam product having a thin skin outer layer. The ethylene vinyl acetate reactor flake is a self-skin foam which does not require separate steps for formation of a skin layer.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A method of producing a particulate polymeric blend for use in the formation of rotationally molded products comprising the steps consisting essentially of:
a) providing polymeric reactor flakes having a melting temperature; and
b) blending into the reactor flakes an effective amount of foaming agent and optional additives to form a particulate polymeric blend wherein the blend is maintained at a temperature below the melting temperature of the reactor flakes.

2. The method of claim 1, wherein the polymeric reactor flakes comprise a member selected from the group consisting of polyethylenes, polypropylenes, polyurethanes, polyvinyl chlorides, polyamides, polyesters, styrenes, ethylvinyl acetates, acrylonitrile-butadiene-styrenes, polycarbonates, acrylonitrile-styrene-acrylates, polyphenylene ethers, fluorocarbons, and mixtures and copolymers thereof.

3. The method of claim 2, wherein the polymeric reactor flake is polyethylene.

4. The method of claim 1, wherein the foaming agent is a member selected from the group consisting of sodium bicarbonate, soda ash, nitrogen, nitrogen producing agents, and mixtures thereof.

5. The method of claim 4, wherein the foaming agent is sodium bicarbonate.

6. The method of claim 1, wherein at least one additive is blended into the reactor flakes.

7. The method of claim 6, wherein the at least one additive is a member selected from the group consisting of dispersion agents, enhancers, stabilizers, colorants, fillers, crosslinking agents, plasticizers, static inhibitors, pentaerythritol monooleate, glycerol monostearate, mineral oil, lubricants, flame retardants, binders, and mixtures thereof.

8. The method of claim 1, wherein the polymeric reactor flake has an average particle size of from about 10 mesh to about 100 mesh.

9. The method of claim 8, wherein the polymeric reactor flake has an average particles size of about 35 mesh.

10. The method of claim 9, wherein filler is added to the blend, said filler being a member selected from the group consisting of fiberglass, wood, wood flour, cellulose, waste paper, waste pulp, glass, glass beads, recycled plastics, carbon black, titanium dioxide, and mixtures thereof.

11. The method of claim 1, wherein the reactor flake is not exposed to temperatures above about 90° C. prior to molding.

12. A method of producing a polymeric product consisting essentially of:
a) providing polymeric reactor flakes having a melting temperature;
b) blending into the reactor flakes an effective amount of foaming agent and optional additives to form a particulate polymeric blend such that the blend is maintained at a temperature below the melting temperature of the reactor flakes; and
c) molding the particulate polymeric blend under pressure and/or heat to form a polymeric product, wherein the molding is performed by a process selected from the group consisting of rotational molding, blow molding, injection molding, sheet molding, static molding, and combinations thereof.

13. The method of claim 12, wherein the polymeric reactor flakes comprise a member selected from the group consisting of polyethylenes, polypropylenes, polyurethanes, polyvinyl chlorides, polyamides, polyesters, styrenes, ethylvinyl acetates, acrylonitrile-butadiene-styrenes, acrylonitrile-styrene-acrylates, polycarbonates, polyphenylene ethers, fluorocarbons, and mixtures and copolymers thereof.

14. The method of claim 12, wherein the foaming agent is a member selected from the group consisting of sodium bicarbonate, soda ash, nitrogen, nitrogen producing agents, and mixtures thereof.

15. The method of claim 14, wherein the foaming agent is sodium bicarbonate.

16. The method of claim 12, wherein at least one additive is blended into the reactor flakes.

17. The method of claim 16, wherein the at least one additive is a member selected from the group consisting of dispersion agents, enhancers, stabilizers, colorants, fillers, crosslinking agents, plasticizers, static inhibitors, pentaerythritol monooleate, glycerol monostearate, mineral oil, lubricants, flame retardants, binders, and mixtures thereof.

18. The method of claim 17, wherein the additive is pentaerythritol monooleate.

19. The method of claim 12, further comprising the step of molding a polymeric skin portion of the molded product using compounded polymeric material prior to the step of molding the particulate polymeric blend.

20. The method of claim 12, wherein the step of molding is performed by rotational molding.

21. A molded product produced by the method of claim 12.

22. A method of producing a molded polymeric product consisting essentially of:
a) blending into a first portion of reactor flakes under low heat conditions an effective amount of foaming agent and optional additives to form a particulate foamable polymeric blend;
b) blending into a second portion of reactor flakes under low heat conditions an effective amount of optional additives to form a particulate polymeric blend for use as a skin;
c) introducing the particulate polymeric blend into a mold and molding under pressure and/or heat to form a skin portion of a polymeric product, wherein the molding is performed by a process selected from the group consisting of rotational molding, blow molding, injection molding, sheet molding, static molding, and combinations thereof; and
d) introducing the particulate foamable polymeric blend into the mold and foaming the foamable polymeric blend to produce a foamed-skin final product.

23. The method of claim 22, wherein the first portion and second portion of reactor flakes are substantially the same material.

24. The method of claim 22, wherein the first portion and second portion of reactor flakes have differing melt indexes and wherein said reactor flakes each comprises the same polymer.

25. The method of claim 22, wherein the step of introducing the particulate foamable polymeric blend is performed during cooling of the skin portion.

26. A molded product produced by the method of claim 22.

27. A method of producing a particulate polymeric blend for use in the formation of rotationally molded products comprising:
a) providing polymeric reactor flakes; and
b) blending into the reactor flakes an effective amount of foaming agent and
optional additives to form a particulate polymeric blend,
such that the reactor flake having a melting temperature and particulate polymeric blend are not exposed to temperatures above the melting temperature of the reactor flake prior to molding.

28. The method of claim 27, wherein the reactor flake is not exposed to temperatures above about 90° C. prior to molding.

29. The method of claim 27, wherein the particulate polymeric blend contains no catalyst scavengers or anti-foaming agents.
